(19) United States
(12) Patent Application Publication
(10) Pub. No.: US 2009/0308749 A1
(43) Pub. Date: Dec. 17, 2009

(54) Electrophorsis Device Having Collecting Well for Dna Purification

(76) Inventor: Jong Tae Park, Gwangju (KR)

Correspondence Address: THE NATH LAW GROUP, 112 South West Street, Alexandria, VA, 22314, US

(21) Appl. No.: 12/225,858

(22) PCT Filed: Apr. 3, 2007
(86) PCT No.: PCT/KR2007/001618

§ 371 Date: Oct. 1, 2008

(30) Foreign Application Priority Data
Apr. 3, 2006 (KR) 10-2006-0030086

(51) Int. Cl. G02F 1/167

(52) U.S. Cl. 204/456

(57) ABSTRACT

The present invention provides an electrophoresis device, which identifies and quickly collects amplified DNA through electrophoresis, thus easily providing purified DNA without executing a complicated process. The electrophoresis device includes a tank for containing a buffer solution therein; a gel placed in the tank and provided with loading wells for loading a DNA sample therein and collecting wells for collecting the DNA sample, migrated from the loading wells; a comb unit for forming the loading wells and the collecting wells in the gel; and a power supply unit for supplying electric current to the tank.

### TECHNICAL FIELD

The present invention relates, in general, to electrophoresis devices and, more particularly, to an electrophoresis device, which identifies and quickly collects amplified DNA through electrophoresis, thus easily providing purified DNA without executing a complicated process.

### BACKGROUND ART

For use in molecular biological research, the fundamental material thereof, genomic and/or plasmid DNA, must essentially be amplified.

DNA is generally amplified through i) PCR (polymerase chain reaction), in which 25-30 thermal cycles are mechanically conducted, with a reaction mixture containing a gene of interest and primers in the presence of polymerase, and/or ii) the proliferation of a transformed cell, prepared by inserting a vector carrying a gene of interest into a v iable cell (e.g., modified E. coli). In the related art, the amplified DNA, processed through the amplification method, is called “a plasmid DNA”.

Such DNA, whether amplified by PCR or by cell culture, is used in various molecular biological studies, including base sequence analysis, base polymorphism or variation, gene expression, gene manipulation and gene cloning, transformation, etc.

DNA products, obtained by PCR or cell culture, must be purified before use. In this regard, conventionally, DNA of interest is identified in an electrophoresis device, followed by purification.

A description will be given of a conventional technique for the identification and purification of a PCR product, below.

FIG. 1 is a view illustrating the construction of a conventional electrophoresis device. FIG. 2 is a view illustrating a gel and a comb for wells, used in the conventional electrophoresis device.

With reference to the drawings, in the related art, to identify amplified DNA using the conventional electrophoresis device, an agarose gel 13 produced with a TAE buffer (tris-acetate buffer) or a TBE buffer (tris-borate buffer) is placed in a tank 11, containing the TAE or TBE buffer, and is subjected to an electric field generated by the application of electric current from a power supply unit 12 to the electrode of the tank 11 having the same buffer. Under these conditions, DNA loaded in the wells migrates in one direction and is then visualized with dye.

As shown in FIG. 2, in the conventional electrophoresis device 10, a plurality of wells 13a is formed in the gel 13 using a comb 15. Thereafter, a DNA sample is loaded in the wells 13a and electric current is applied to the electrode of the tank 11, thus making the DNA sample pass between the particles in the gel 13.

After the identification of DNA on the basis of the migration distance in the electrophoresis device, a piece of gel containing the DNA is excised.

DNA is then purified from the gel piece using a spin column containing various reactants and silica or an ion exchanger. This purification technique generally requires three or four additional purification processes, and, taking into account one centrifugation process conducted between the purification processes, the total number of process amounts finally to five to seven.

In a second method for purifying the amplified DNA, which has been amplified through the PCR method, the amplified state of a small part of the amplified DNA is first identified through electrophoresis and, thereafter, the remaining part of the amplified DNA is purified. However, the process of the second purification method is almost equal to that of the first method for purifying the amplified DNA using the gel piece.

Thus, when it is necessary to purify a plurality of amplified DNA samples, the purification process becomes complicated and requires excessive labor and excessive processing time.

In the conventional purification method, as described above, a kit including an exhaustible spin column is needed for each DNA sample, requiring many reaction processes and a centrifugation process between the reaction processes. Therefore, the conventional purification method suffers from the disadvantage of being complicated and requiring high processing cost and excessive processing time.

### DISCLOSURE OF INVENTION

### Technical Problem

Accordingly, the present invention has been made keeping in mind the above problems occurring in the related art, and an object of the present invention is to provide an electrophoresis device, which has DNA collecting wells for DNA purification and quickly collects the amplified DNA in the DNA collecting wells when the DNA migrates in one direction due to an electric field generated in a buffer solution contained in a tank placed in the electrophoresis device, thus easily providing purified DNA without separately executing a complicated DNA purification process.

### Technical Solution

In order to accomplish the above object, in an aspect, the present invention provides an electrophoresis device, comprising: a tank for containing a buffer solution therein; a gel placed in the tank and provided with a loading well for loading a DNA sample therein and a collecting well for collecting the DNA sample, migrated from the loading well; a comb unit for forming the loading well and the collecting well in the gel; and a power supply unit for supplying electric current to the tank.

In a preferred embodiment, the comb unit comprises: a loading well comb pan for forming the loading well for loading the DNA sample therein; and a collecting well comb part for forming the collecting well for collecting the DNA sample, migrated from the loading well, wherein the interval between the loading well comb part and the collecting well comb pail is adjustable.

In a preferred embodiment, each of the buffer solution contained in the tank, a buffer solution used for forming the gel, and a buffer solution contained both in the loading well and in the collecting well is a TE buffer solution.

In a preferred embodiment, the depth of the collecting well formed in the gel is deeper than that of the loading well, and the surface area of the collecting well is larger than that of the loading well.

In a preferred embodiment, the collecting well has four corners, wherein one of the four corners is slightly deeper than the three remaining corners.

In a preferred embodiment, the slightly deeper corner of the collecting well is a corner far from the loading well.

### ADVANTAGEOUS EFFECTS

Unlike a conventional DNA purification technique in which a plurality of processes is executed to purify DNA, the DNA purification technique according to the present invention purifies DNA through one process, so that the present invention is advantageous in that it remarkably reduces both the DNA purification cost and the DNA purification time. In other words, unlike the conventional technique, in which a plurality of DNA purification processes must be executed to provide purified DNA, the technique of the present invention easily and quickly provides purified DNA without requiring a separate purification process to be executed, because the DNA, collected in the collecting well, has been purified.

Further, another advantage of the present invention resides in the fact that different kinds of DNA samples can be purified at the same time by controlling the number of loading wells and the number of collecting wells.

### BRIEF DESCRIPTION OF THE DRAWINGS

FIG. 1 is a view illustrating a conventional electrophoresis device;

FIG. 2 is a view illustrating a gel and the shape of a comb unit, used in the conventional electrophoresis device;

FIG. 3 is a view illustrating the construction of an electrophoresis device according to a preferred embodiment of the present invention;

FIG. 4 is a view illustrating the construction of a comb unit used in the electrophoresis device according to the present invention;

FIG. 5 is a side view of the comb unit of FIG. 4;

FIG. 6 is a side sectional view of a gel of FIG. 4, in which a plurality of loading wells and a plurality of collecting wells is formed by the comb unit;

FIG. 7 is a plan view of the gel of FIG. 4, in which the loading wells and the collecting wells are formed by the comb unit; and

FIG. 8 is a view illustrating the process of forming the wells in the gel using the comb unit.

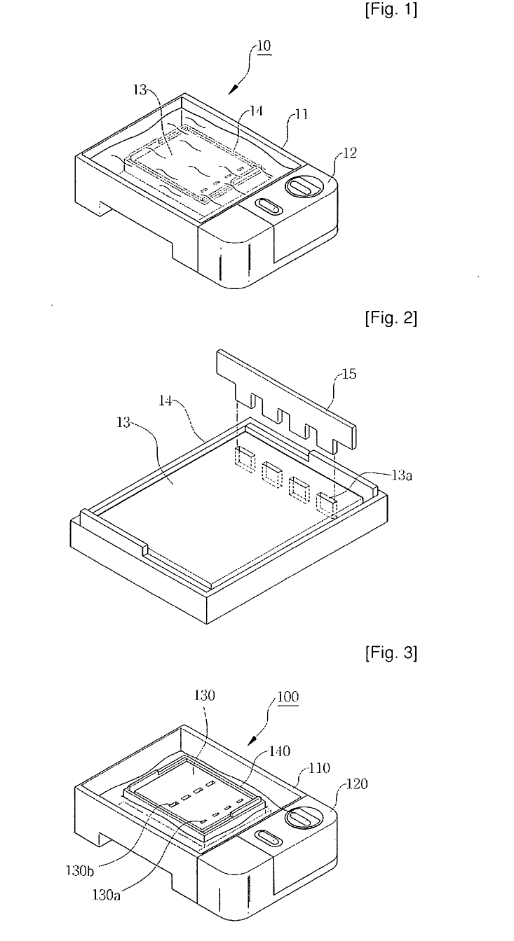

### DESCRIPTION OF REFERENCE CHARACTERS OF IMPORTANT PARTS

10, 100: electrophoresis device
11, 110: tank
12, 120: power supply unit
13, 130: gel
14, 140: gel casing
15, 150: comb unit

### BEST MODE FOR CARRYING OUT THE INVENTION

Herein below, a preferred embodiment of the present invention will be described in detail with reference to the accompanying drawings. In the drawings, elements having the same construction and the same function carry the same reference numerals.

FIG. 3 is a view illustrating the construction of an electrophoresis device according to a preferred embodiment of the present invention.

As shown in the drawing, the electrophoresis device 100 according to the preferred embodiment of the present invention comprises a tank 110, a power supply unit 120, a gel 130, a gel casing 140, and a comb unit 150.

The gel 130, in which a DNA sample is processed through electrophoresis, is placed in the tank 110. The tank 130 contains a sufficient amount of buffer solution therein, such that the gel 130 does not completely sink in the solution.

The gel 130 is produced by mixing the buffer solution, and has a plurality of loading wells and a plurality of collecting wells. The DNA sample is loaded in the loading wells, and the DNA, which migrates from the loading wells, is collected in the collecting wells.

The gel 130 is placed in the tank 110 in the state in which it is contained in the gel casing 140. Further, an appropriate amount of buffer solution is put in the tank 110 such that the upper surface of the gel 130 does not sink in the solution.

The power supply unit 120 supplies electric current to an electrode of the electrophoresis device 100 having the tank 110, which contains the gel 130 therein, so that an electric field is generated in the buffer solution contained in the tank 110.

The comb unit 150 is used for forming both the loading wells and the collecting wells in the gel 130.

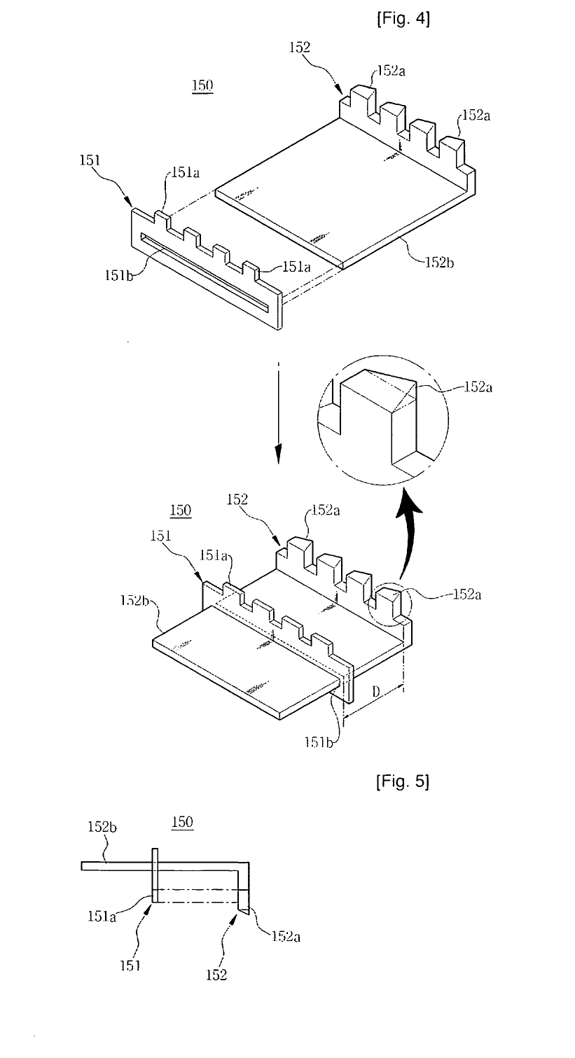

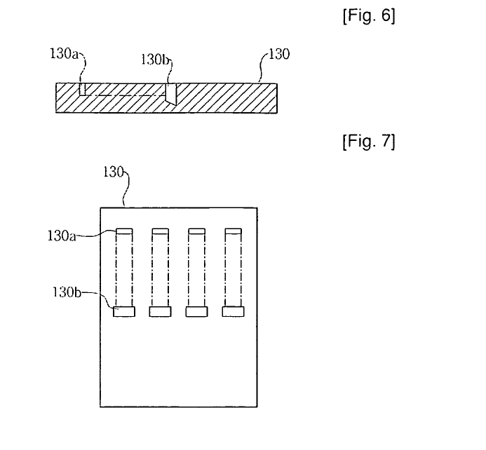

FIG. 4 is a view illustrating the construction of the comb unit used in the electrophoresis device according to the present invention. FIG. 5 is a side view of the comb unit of FIG. 4. FIG. 6 is a side sectional view of the gel of FIG. 4, in which both the loading wells and the collecting wells are formed by the comb unit. FIG. 7 is a plan view of the gel of FIG. 4, in which both the loading wells and the collecting wells are formed by the comb unit.

As shown in the drawings, the comb unit 150 comprises a loading well comb part 151 and a collecting well comb pan 152. The loading well comb part 151 is used for forming the loading wells 130a for loading a DNA sample therein. The collecting well comb part 152 is used for forming the collecting wells 130b for collecting the DNA sample, migrated from the loading wells 130a.

The loading well comb part 151 is a toothed plate having a plurality of teeth 151a. The collecting well comb part 152 has a toothed pan, which has a plurality of teeth 152a and is integrated with a rectangular support plate 152b. The toothed plate, which constitutes the loading well comb part 151, is fitted over the rectangular support plate 152b of the collecting well comb part 152, thus forming the comb unit 150.

The loading well comb part 151 is provided with a longitudinal slot 151b. The rectangular support plate 152b of the collecting well comb part 152 is inserted into the longitudinal slot 151b of the loading well comb part 151, and supports the loading well comb part 151.

The loading well comb part 151, which is fitted over the support plate 152b through the longitudinal slot 151b, is movable along the support plate 152b, so that the interval between the teeth 151a of the loading well comb part 151 and the teeth 152a of the collecting well comb part 152 is adjustable.

The comb unit 150 forms both the loading wells 130a and the collecting wells 130b in the gel 130. The depth of the collecting wells 130b, which are formed in the gel 130, is slightly deeper than that of the loading wells 130a. Further, the length and width of the collecting wells 130b are slightly larger than those of the loading wells 130a.

In other words, the length of each tooth 152a of the collecting well comb part 152 is longer than the length of each tooth 151a of the loading well comb part 151. Further, the width and length of the end of each tooth 152a of the collecting well comb part 152 are slightly greater than those of the end of each tooth 151a of the loading well comb part 151.

Further, each of the collecting wells 130b has four corners on the bottom surface thereof, one of the four corners being slightly deeper than the three remaining corners. In other words, one of the four corners of the rectangular bottom surface of each of the collecting wells 130b is shaped as a downward pointed corner, so that the DNA sample can be easily collected in the collecting wells 130b and the collected DNA sample can be easily gathered from the collecting wells 130b.

Further, the slightly deeper corner of each of the collecting wells 130b is one of the two corners that are far from the loading wells 130a.

Hereinbelow, the operation of the electrophoresis device having the above-mentioned construction will be described.

First, to obtain purified DNA using the electrophoresis device, the gel 130 to be placed in the electrophoresis device must be produced.

The gel 130 is produced by mixing agarose powder with a TE buffer and heating the mixture. Thereafter, both the loading wells 130a and the collecting wells 130b are formed in the gel 130 using the comb unit 150.

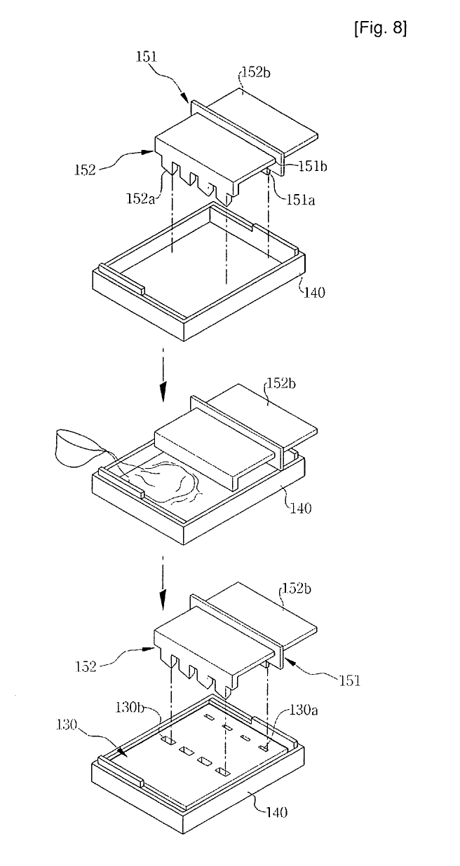

FIG. 8 is a view illustrating the process of forming the wells in the gel using the comb unit.

As shown in FIG. 8, the comb unit 150 is placed on the gel casing 140, and the gel, in a liquid phase, is carefully poured into the gel casing 140. After the liquid phase gel in the gel casing 140 is solidified into a solid phase, the comb unit 150 is removed from the gel casing 140 in an upward direction, so that the loading wells 130a and the collecting wells 130b remain in the gel 130 due to the teeth 151a of the loading well comb part 151 and the teeth 152a of the collecting well comb part 152 of the comb unit 150.

After the gel 130, having the loading wells 130a and the collecting wells 130b, is completely produced in the gel casing 140, the gel casing 140 containing the gel 130 is installed in the tank 110 of the electrophoresis device.

Further, a buffer solution is contained in the tank 110. The buffer solution to be contained in the tank 110 uses a TE buffer (Tris EDTA buffer). In the above state, an appropriate amount of buffer solution is put in the tank 110 such that the gel 130 does not completely sink in the solution, but so that the upper surface of the gel 130 is exposed outside the solution. If so much buffer solution is put in the tank 110 that the gel 130 completely sinks in the solution, the buffer solution may become mixed with the DNA sample, which is contained in the loading wells or the collecting wells of the gel 130, and thus the DNA sample may be contaminated.

Further, the TE buffer is also contained in the collecting wells 130b.

Thereafter, a DNA sample is loaded in the loading wells 130a of the gel 130. After the DNA sample is loaded in the loading wells 130a of the gel 130, the gel 130 is placed in the tank 110, with the buffer solution contained in the tank 110. Thereafter, electric current is applied to the electrode of the electrophoresis device from the power supply unit 120, thus generating an electric field in the buffer solution contained in the tank 110.

The DNA has an electric polarity, so that, when electric current is applied to the electrode of the electrophoresis device, the DNA sample, which has been loaded in the loading wells 130a, migrates in one direction to the collecting wells 130b.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides an electrophoresis device having both the loading wells and the collecting wells. In the present invention, the DNA, collected in the collecting wells, is the purified DNA, so that it is not necessary to separately execute a complicated DNA purification process. Further, different kinds of DNA samples can be purified at the same time by controlling both the number of the loading wells and the number of the collecting wells. Thus, the electrophoresis device of the present invention can be efficiently used in electrophoresis for DNA analysis.

1. An electrophoresis device, comprising:
a tank for containing a buffer solution therein;
a gel placed in the tank and provided with a loading well for loading a DNA sample therein and a collecting well for collecting the DNA sample, migrated from the loading well;
a comb unit for forming the loading well and the collecting well in the gel; and
a power supply unit for supplying electric current to the tank.

2. The electrophoresis device according to claim 1, wherein the comb unit comprises:
a loading well comb part for forming the loading well for loading the DNA sample therein; and
a collecting well comb part for forming the collecting well for collecting the DNA sample, migrated from the loading well, wherein
an interval between the loading well comb part and the collecting well comb part is adjustable.

3. The electrophoresis device according to claim 2, wherein a depth of the collecting well formed in the gel is deeper than that of the loading well, and a length and width of the collecting well are greater than those of the loading well.

4. The electrophoresis device according to claim 3, wherein the collecting well has four corners, wherein one of the four corners is deeper than the three remaining corners.

5. The electrophoresis device according to claim 4, wherein the deeper corner of the
collecting well is a corner far from the loading well.

6. A comb unit used in an electrophoresis device, comprising:
a loading well comb part for forming a plurality of loading wells for loading a DNA sample therein; and
a collecting well comb part for forming a plurality of collecting wells for collecting the DNA sample migrated from the loading wells, wherein
an interval between the loading well comb part and the collecting well comb part is adjustable.

7. The comb unit according to claim 6, wherein
the loading well comb part has a plurality of loading well teeth along an edge thereof; and
the collecting well comb part has a plurality of collecting well teeth along an edge thereof, wherein
a length of each of the collecting well teeth is longer than that of each of the loading well teeth.

8. The comb unit according to claim 7, wherein
a width and length of an end of each of the collecting well teeth are slightly greater than those of the end of each of the loading well teeth.

9. The comb unit according to claim 7, wherein
an end of each of the collecting well teeth has four corners, wherein one of the four corners is higher than the three remaining corners.
